(19) United States
(12) Patent Application Publication
(10) Pub. No.: US 2007/0153437 A1
(43) Pub. Date: Jul. 5, 2007

(54) Electrostatic discharge protection of an electronic circuit

(76) Inventors: Rainer Bartenschlager, Kaufbeuren (DE); Alexander Icaza Deckelmann, Munchen (DE); Christoph Kaul, Munchen (DE); Martin Streibl, Petershausen (DE)

Correspondence Address: DICKE, BILLIG & CZAJA, FIFTH STREET TOWERS, 100 SOUTH FIFTH STREET, SUITE 2200, MINNEAPOLIS, MN, 55402, US

(21) Appl. No.: 11/642,039

(22) Filed: Dec. 18, 2006

(30) Foreign Application Priority Data
Dec. 16, 2005 (DE) 10 2005 060 368.8

(51) Int. Cl. H02H 9/00

(52) U.S. Cl. 361/56

(57) ABSTRACT

A method of electrostatic discharge (ESD) protection of an electronic circuit includes coupling a first circuit point of the electronic circuit to a first capacitance, coupling a second circuit point of the electronic circuit to a second capacitance, and substantially diverting an ESD voltage pulse occurring at the first circuit point via the second circuit point with the second capacitance.

### CROSS-REFERENCE TO RELATED APPLICATIONS

This Utility Patent Application claims priority to German Patent Application No. DE 10 2005 060 368.8 filed on Dec. 16, 2005, which is incorporated herein by reference.

### BACKGROUND

Conventional electronic circuits generally have protection against electrostatic discharge (ESD). For reasons of cost defaults and for reasons of defaults relating to maximum surface or proportion of the electronic circuit to be used for ESD protection, appropriate ESD measures which can be implemented on the electronic circuit or outside the electronic circuit, are often configured in such a way that a voltage occurring in a case of ESD is diverted only inadequately, thereby increasing at least the probability of the electronic circuit being damaged in a case of ESD. This applies in particular if the electronic circuit is a modern dynamic random access memory (DRAM) circuit or other similar modem memory circuit.

For these and other reasons there is a need for the present invention.

### SUMMARY

One embodiment provides a method of electrostatic discharge (ESD) protection of an electronic circuit. The method includes coupling a first circuit point of the electronic circuit to a first capacitance. The method includes coupling a second circuit point of the electronic circuit to a second capacitance. The method includes substantially diverting an ESD voltage pulse occurring at the first circuit point via the second circuit point with the second capacitance.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a schematic diagram illustrating a conventional microelectronic circuit with ESD protection.

FIG. 2 is a schematic diagram illustrating one embodiment of a microelectronic circuit with ESD protection.

FIG. 3 is a diagram illustrating a voltage curve in a case of ESD in one embodiment of a microelectronic circuit compared with a voltage curve in a conventional microelectronic circuit.

FIG. 4 is a schematic diagram illustrating a microelectronic circuit with conventional ESD protection.

FIG. 5A is a schematic diagram illustrating one embodiment of a microelectronic circuit with ESD protection.

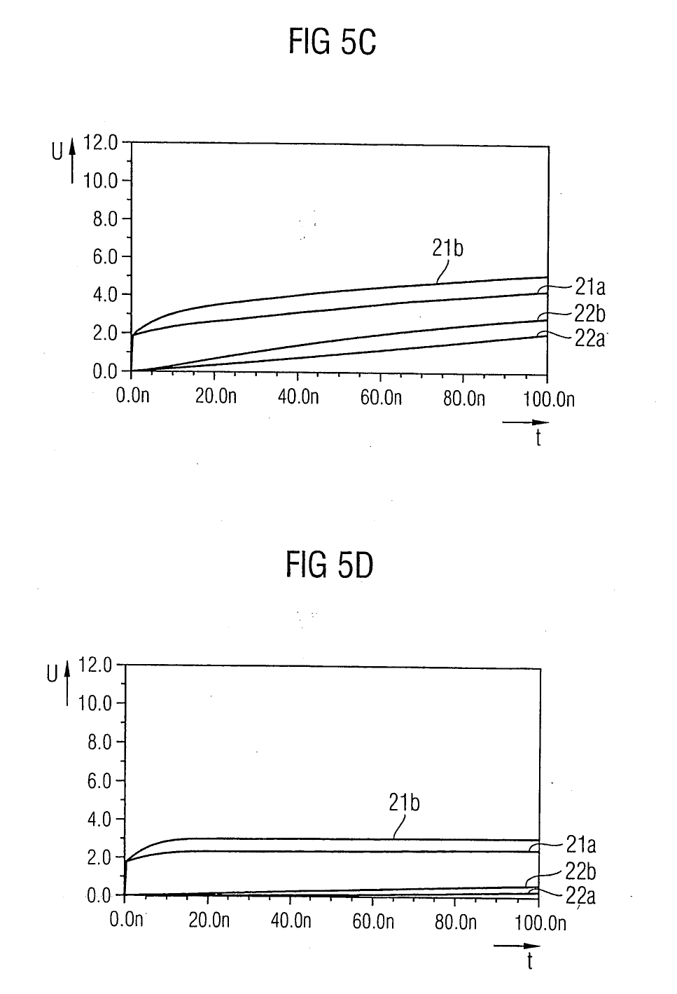

In FIGS. 5B-5D are diagrams illustrating simulation results of the microelectronic circuit embodiment illustrated in FIG. 5A quantified compared with a conventional microelectronic circuit.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,”“bottom,”“front,”“back,”“leading,”“trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Embodiments relate to a method for ESD protection of an electronic circuit and an appropriately configured electronic circuit.

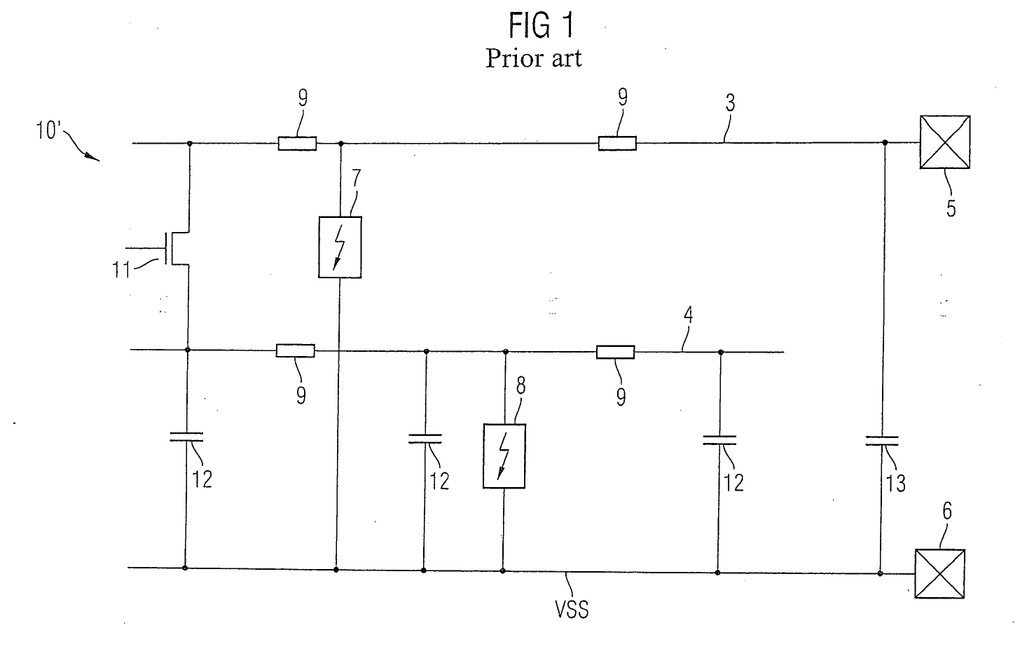

FIG. 1 illustrates a conventional microelectronic circuit 10′, which has two voltage supply pins 5, 6 accessible from outside the circuit. One voltage supply pin 5, connected to an external voltage supply line 3, is coupled at VDD and the other voltage supply pin 6 is coupled at Vₛₛ. The first voltage supply line 3 is connected to an internal voltage supply line 4 via a transistor 11 operating as regulator. This internal voltage supply line 4, by which the majority of the microelectronic circuit 10′ is directly supplied, is connected to numerous buffer capacitances, while the external voltage supply line 3 is connected to only a small number of buffer capacitances 13. In other words, the capacity of buffer capacitances 12, to which the internal voltage supply line 4 is connected is considerably larger than the capacity of buffer capacitances 13 to which the external voltage supply line 3 is connected.

For ESD protection, in the conventional microelectronic circuit 10′ the external voltage supply line 3 is connected to Vₛₛ by a first ESD protection device 7 and in a similar way the internal voltage supply line 4 is likewise connected to Vₛₛ via a second ESD protection device 8. A voltage occurring in a case of ESD is supposed to be diverted via the first ESD protection device 7 or the second ESD protection device 8.

The functions of these ESD protection devices 7, 8 are frequently impaired by parasitic resistors inside the voltage supply line 3, 4, which are present because of placing conditions (i.e., design defaults in the design of the electronic circuit) and dimensional conditions of the voltage supply lines (also referred to as voltage supply bars). Specifically in the case of the external voltage supply line 3, these parasitic resistors ensure that in a case of ESD a voltage which is supposed to be diverted via the external voltage supply line 3 and the ESD protection device 7 connected thereto adopts extremely high values, so the appropriate components, such as the transistor 11, may be damaged.

On the other hand, in a case of ESD relating to the internal voltage supply line 4 (i.e., if in a case of ESD a voltage is supposed to be diverted via the internal voltage supply line 4 and ESD protection device 8) a voltage value of such a size as in a case of ESD relating to the external voltage supply line 3 does not occur, as the charge accompanying the case of ESD can be diverted to the large buffer capacitances 12 connected to the internal voltage supply line 4. For example, according to a human body model (HBM) 100 pF are mentioned relating to a case of ESD, wherein the capacities of the buffer capacitances connected to the internal voltage supply line 4 have a capacity in the range of 100 nF or more. This means that in a case of ESD a charge arising according to the HBM can easily be diverted on to the buffer capacitances 12, without a dangerous voltage peak arising or a dangerous amount of energy being diverted into a component of the microelectronic circuit 10′.

One embodiment provides a method for ESD protection of an electronic circuit having a first and a second circuit point. The first circuit point has a first capacitance. The second circuit point has a second capacitance, which is considerably larger (e.g., larger by more than a factor of 10) than the first capacitance. In a case of ESD, an ESD voltage pulse which occurs at the first circuit point is substantially diverted via the second circuit point by means of its second capacitance.

In that the ESD voltage pulse is diverted on to the second circuit point and therefore on to the second capacitance, the first circuit point is better protected with one embodiment in a case of ESD than is conventionally the case. This is particularly the case if the second capacitance is of such a size that it can absorb a discharge occurring in a case of ESD, without a voltage applied via it thereby increasing.

In one embodiment, the first capacitance is arranged between the first circuit point and a supply potential and the second capacitance between the second circuit point and the same supply potential (e.g., ground). In this way, in a case of ESD the ESD voltage pulse is diverted from the first circuit point on to the second circuit point and from there via the second capacitance on to the supply potential (e.g., ground).

Specifically when the supply potential is ground it is possible for the charge flowing on to the second capacitance in a case of ESD to flow easily away to the ground via leakage currents.

The first circuit point may be located on an external supply potential. The second circuit point may be located on an internal supply potential. The second circuit point may, though, be located on a further external supply potential.

In one embodiment, if in a case of ESD an excess voltage is conducted away from the first circuit point on to the second circuit point via diodes connected in series, in normal operation (i.e., non-ESD case) a potential difference between a potential of the first circuit point and a potential of the second circuit point is determined via the sum of the cut-off voltages of these diodes connected in series. In one embodiment, it is advantageous if the potential difference is less than half the sum of the cut-off voltages. For example, if the excess voltage in a case of ESD is diverted via only one diode, which has a cut-off voltage of 0.7V, the potential difference in normal operation is, for example, around 0.3V (i.e., the potential of the first circuit point is 0.3V higher than the potential of the second circuit point).

One embodiment of an electronic circuit includes a first and a second circuit point. The first circuit point is coupled to a first capacitance. The second circuit point is coupled to a second capacitance, which is considerably larger than the first capacitance. A device of the electronic circuit is arranged between the first circuit point and the second circuit point and is configured in a case of ESD, to divert an ESD voltage pulse which occurs at the first circuit point to the second circuit point, from where the voltage pulse is diverted via the second capacitance.

Some advantages of the electronic circuit according to embodiments correspond to the advantages discussed above related to method embodiments.

In one embodiment of an electronic circuit, it is advantageous if the first and the second circuit points are close together with respect to their potential if the electronic circuit is being operated normally. This is the case, for example, if the potential of the second circuit point is fed via the potential of the first circuit point. In this case, the potential of the second circuit point is below the potential of the first circuit point (e.g., the potential of the second circuit point amounting to not less than 50% of the potential of the first circuit point).

A normally operated circuit is understood to be a case where the circuit is in active operation, it being supplied with voltage according to its technical configuration. For example, a circuit not supplied with voltage or a circuit just charged by an ESD voltage pulse are not in a category of a normally operated circuit.

If the potentials of the two circuit points are close together, one embodiment of a device for conducting away a charge occurring in a case of ESD can be configured in such a way that it reacts even in the case of small voltage fluctuations of the first circuit point (i.e., it can be configured relatively sensitively). Put another way, it is easier to implement one embodiment of the device sensitively with respect to a voltage fluctuation if a potential difference between the input and the output of the device is small.

In one embodiment, leakage currents which flow via the device during normal operation of the electronic circuit are smaller, the smaller the potential difference is between the input and the output of a device embodiment.

In other words, device embodiments for ESD protection can have advantages with respect to sensitivity and energy loss owing to leakage flows compared with ESD protection devices arranged between the first circuit point and ground. For example, if the potentials of the first and the second circuit points are close together, as the potential difference between the potential of the first circuit point and ground is large in comparison to the potential difference between the two circuit points.

Electronic circuit embodiments may also have ESD protection arrangements (e.g., thyristor structures or appropriately configured bipolar transistors) arranged between the first circuit point and ground and/or between the second circuit point and ground.

While the device embodiments can provide very good ESD protection, for example, in the case of high-frequency ESD voltage pulses, the ESD protection of the electronic circuit can be improved by the ESD protection arrangements with respect to low-frequency ESD voltage pulses, which can be better diverted to ground by these ESD protection arrangements. Moreover, embodiments of ESD protection arrangements between the second circuit point and ground can help to reduce a charge building up on the second capacitance because of the currents flowing via the ESD protection arrangements in a case of ESD. In a case where a voltage between the second circuit point and ground is above the break-through voltage of the ESD protection arrangements these currents are break-through currents, whereas in a case where this voltage is below the break-through voltage these currents are leakage currents.

Embodiments are suitable for use in microelectronic circuits (e.g., DRAM circuits or other memory microelectronic circuits). Embodiments are not confined to this area of application, however, as embodiments can also be used in non-microelectronic circuits (e.g., electronic circuits constructed on printed circuit boards).

Embodiments are described below in more detail with reference to the drawings.

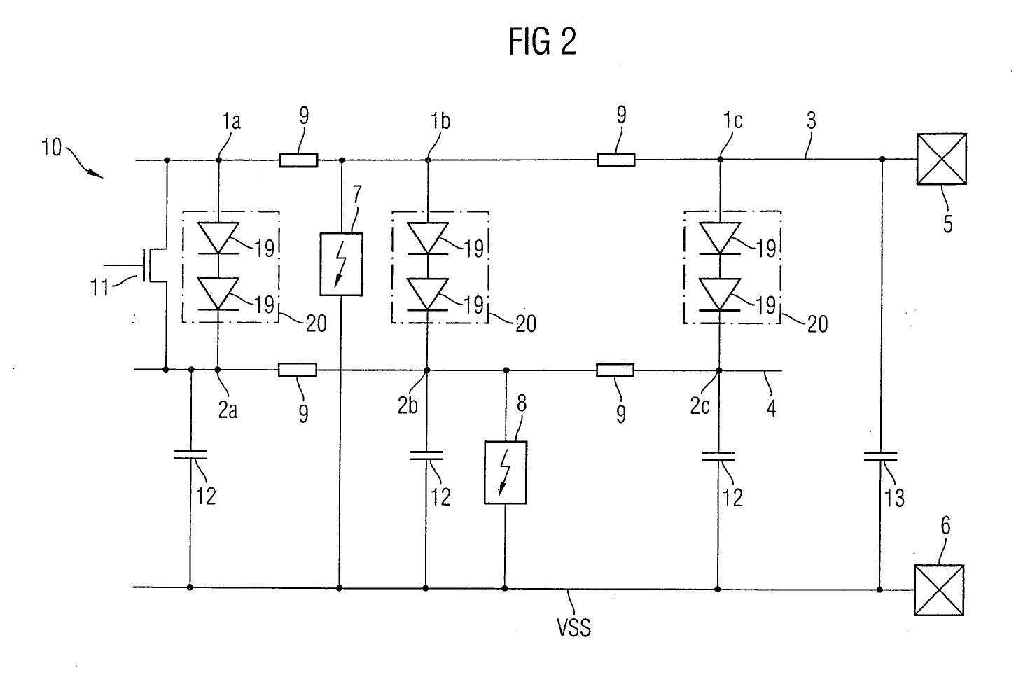

FIG. 2 illustrates a microelectronic circuit 10 according to one embodiment. Microelectronic circuit 10 has an external voltage supply line or voltage supply bar 3, connected to a first pin 5 of the microelectronic circuit 10, and a further external voltage supply line Vₛₛ, connected to a second pin 6 of the microelectronic circuit 10. The voltage supply of the majority of the microelectronic circuit 10 is provided by an internal voltage supply line 4, which is fed via the external voltage supply line 3. The voltage of the internal voltage supply line 4 is regulated via a transistor 11, which is connected by one of its terminals to the external voltage supply line 3 and by its other terminal to the internal voltage supply line 4. Regulation of the voltage of the internal voltage supply line 4 is performed via the potential at the gate of the transistor 11.

In this embodiment three devices 20 are arranged between the external voltage supply line 3 and the internal voltage supply line 4, which in each case connect a circuit point 1a-c on the external voltage supply line 3 to a corresponding circuit point 2a-c on the internal voltage supply line 4 for ESD protection. Each of the three devices 20 according to this embodiment includes two diodes 19 connected in series. In an example, assuming that the cut-off voltage of each diode is around 0.7V, a sum of 1.4V results from the cut-off voltages. As the potential difference between the potential of the external voltage supply line 3 and the internal voltage supply line 4 is, in one embodiment, less than half this sum of 1.4V, the potential difference in the example embodiment is chosen as 0.6V (i.e., the potential of the external voltage supply line 3 is 0.6V above the potential of the internal voltage supply line 4).

Additionally, microelectronic circuit 10 includes a first ESD protection device 7 between the external voltage supply line 3 and the further external voltage supply line Vₛₛ and a second ESD protection device 8 between the internal voltage supply line 4 and the further external voltage supply line Vₛₛ. Both the external voltage supply line 3 and the internal voltage supply line 4 are connected to the further external voltage supply line Vₛₛ, where external voltage supply line 3 is coupled via a small buffer capacitance 13 and internal voltage supply line 4 is coupled via a considerably larger buffer capacitance 12.

Both the illustrated smaller buffer capacitance 13 and the illustrated larger buffer capacitances 12 are of a schematic nature and are not intended to represent a capacitor in each case, for example. A buffer capacitance can be determined between each circuit point 1a-c on the external voltage supply line 3 and the further external voltage supply line Vₛₛ or ground. These buffer capacitances have been summarised schematically in FIG. 2 via the buffer capacitance 13 illustrated for the sake of clarity. In a similar way, the resistors characterised by the reference numeral 9 represent parasitic resistors of the appropriate supply voltage line 3 or 4.

In one embodiment, if a case of ESD occurs, for example in that a person touches the first pin 5, the ESD voltage pulse is diverted via the three devices 20 according this embodiment to the internal voltage supply line 4. As the buffer capacitances 12 connected to the internal voltage supply line 4 have a sufficiently large capacity, the voltage pulse is diverted to these buffer capacitances 12, without excessively loading or even destroying components of the microelectronic circuit 10, such as the transistor 11, for example.

Thus, in the embodiment illustrated in FIG. 2 the transistor 11 acting as voltage regulator is protected virtually optimally by the diodes 19 running parallel to it, as these diodes divert any excess voltage applied above the drain source section of the transistor 11.

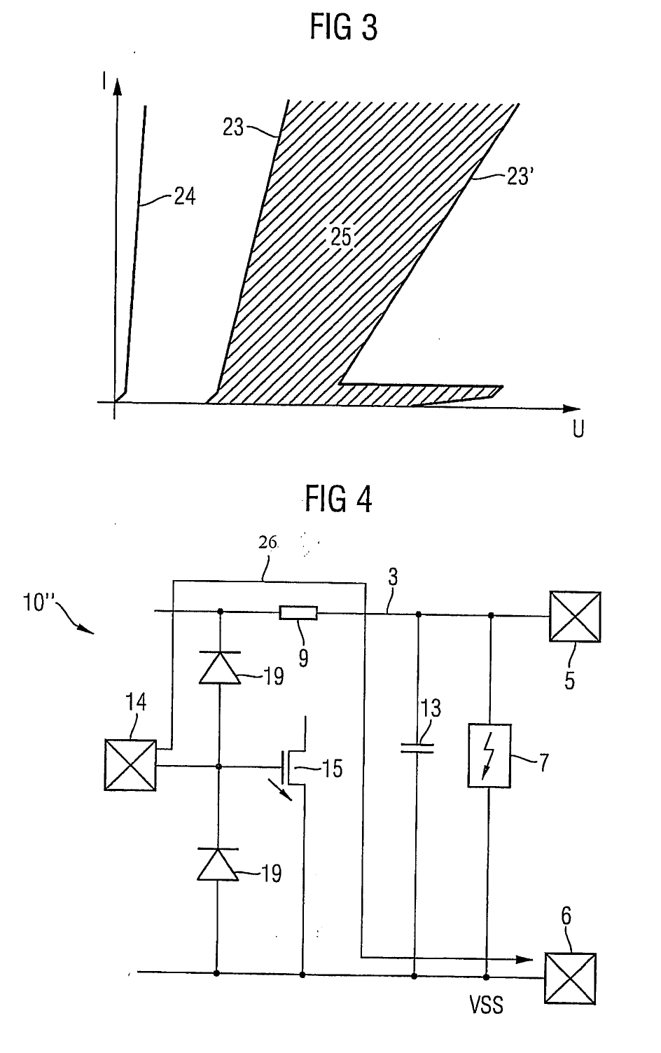

FIG. 3 illustrates three I-V characteristic curves 23, 23′, and 24, wherein in the graph illustrated in FIG. 3 the voltage is represented on the X-axis and the current on the Y-axis. The I-V characteristic curve 23′ represents the course of the current over the voltage for the external voltage supply line 3, if the devices 20 according to embodiments are not present. That means I-V characteristic curve 23′ corresponds to the IV characteristic curve of the external voltage supply line 3 of a conventional microelectronic circuit with an ESD voltage pulse fed via the first pin 5 towards ground. The voltage on the external voltage supply line 3 first has to rise considerably before a thyristor structure 7 breaks down and diverts the-energy fed in by the ESD voltage pulse via ground Vₛₛ.

The potential according to I-V characteristic curve 23 on the external voltage supply line 3 in a case of ESD runs quite differently if the devices 20 according to embodiments are present. In this case, a considerably smaller voltage suffices to overcome the blocked area of the two diodes 19, so the charge occurring in a case of ESD can flow away to the internal voltage supply line 4. As the internal voltage supply line 4 is coupled to large buffer capacitances 12, the voltage on the internal voltage supply line 4 also does not rise very much if the charge flows from the external voltage supply line 3 via the diodes 19 on to the internal voltage supply line 4, as from there it immediately continues to flow to the buffer capacitances 12. The potential curve of the internal voltage supply line 4 is characterised in FIG. 3 by the reference numeral 24.

The area characterised by the reference numeral 25 and shaded in FIG. 3 marks a security range achieved by the devices 20 according to embodiments compared with a microelectronic circuit with conventional ESD protection.

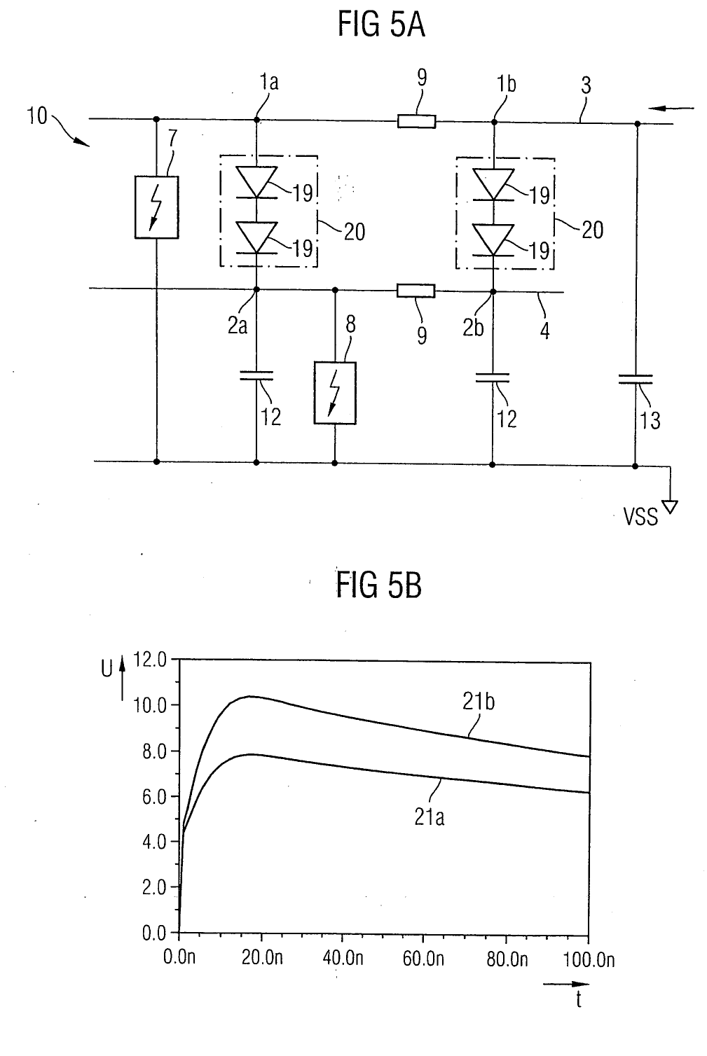

The need for such a security range 25 is further clarified in FIG. 4, which illustrates a microelectronic circuit 10″ with conventional ESD protection. This conventional microelectronic circuit 10″ also has a first pin 5, which is charged by an external voltage supply, and a second pin 6, which is supplied externally by ground. There is additionally a further pin 14, by which a transistor 15 is controlled. For ESD protection a thyristor structure 7 is connected between a voltage supply line 3, connected to the first pin 5 and ground Vₛₛ. Furthermore, there is a protection diode 19 in the flow direction between the third pin 14 and the voltage supply line 3 and a further protection diode 19 in the flow direction between ground Vₛₛ and the third pin 14.

If an ESD voltage pulse now occurs at the third pin 14, this ESD voltage pulse is diverted as indicated along a kinked arrow 26, illustrated, via the upper protection diode 19 to the voltage supply line 3, there via the parasitic resistance 9 and then via the thyristor structure 7 to ground Vₛₛ. The voltage between the pin 14 and ground Vₛₛ is thus equal to the sum of the voltages over the upper protection diode 19, the parasitic resistor 9 and the thyristor structure 7. It should be taken into account here that, for example, the critical voltage level in the gate oxide in the case of a 130 nm CMOS technique is in the order of magnitude of 5V, even for a case of HBM. This means the entire voltage along the kinked arrow 26 should not exceed these 5V during a case of ESD.

If in a case of ESD the voltage is diverted according to embodiments from the external voltage supply line 3 via only a small voltage increase thereon, as illustrated in FIG. 3, the voltage applied in a case of ESD between the gate and the ground terminal of the transistor 15 or applied along the kinked arrow 26 can be reduced according to an amount corresponding to the voltage difference between a point of I-V characteristic curve 23′ and a corresponding point of I-V characteristic curve 23. Thus, in a case of an ESD voltage pulse at the third pin 14 in the microelectronic circuit 10″ illustrated in FIG. 4, if this is protected according to embodiments, such as illustrated in FIG. 2, damage to the transistor 15 can be appreciably more reliably prevented than if this microelectronic circuit 10″ is not protected according to embodiments, as illustrated in FIG. 4.

The ESD protection measures according to the embodiments are verified below with the aid of a simulation. FIG. 5A illustrates a microelectronic circuit 10 according to one embodiment, which substantially corresponds to the microelectronic circuit 10 embodiment illustrated in FIG. 2. The simulation results illustrated in FIGS. 5B-D correspond to an example simulation, wherein an HBM occurrence with 2 KV at the first pin 5 is assumed (in FIG. 5A illustrated by the arrow at the top right). In this example embodiment, the parasitic resistor 9 in the external voltage supply line 3 has been assumed at 2 Ohms and the parasitic resistor 9 in the internal voltage supply line 4 at 1 Ohm. The buffer capacitance 13 can be ignored with respect to the buffer capacitances 12 (i.e., it is smaller by at least a factor of 10).

In FIG. 5B, potential curve 21a is illustrated at the first circuit point a and potential curve 21b at the second circuit point 1b on the external voltage supply line 3 for a case where the devices 20 according to embodiments (e.g., the diodes 19) are not present. On the other hand, in FIG. 5C potential curve 21a of the first circuit point 1a and potential curve 21b of the second circuit point 1b on the external voltage supply line 3 and potential curve 22a of the first circuit point 2a and potential curve 22b of the second circuit point 2b on the internal voltage supply line 4 are illustrated. The two buffer capacitances 12 have been simulated in each case at 20 nF. The maximum values in potential curves 21a, b of circuit points 1a, b on the external voltage supply line 3 in the microelectronic circuit 10 according to embodiments turn out considerably smaller than if the two devices according to embodiments (e.g., the diodes 19) are not present, corresponding to a microelectronic circuit with conventional ESD protection. While the maximum value of potential curve 21b without the devices 20 according to embodiments results in a value above 10V, in potential curve 21b in the microelectronic circuit 10 according to the embodiment illustrated in FIG. 5A with devices 20 according to embodiments, at the same time, in other words approximately 10 ns after the start of the ESD voltage pulse, this value is approximately 3V, corresponding to a difference of 7V, which in the case of today's microelectronic circuits, which have supply voltages of 5V and less, is a dramatic difference.

FIG. 5D illustrates potential curves 21a, b for circuit points 1a, b on the external voltage supply line 3 and potential curves 22a, b of circuit points 2a, b on the internal voltage supply line in a case where the buffer capacitances 12 of the internal voltage supply line 4 amount to 100 nF in each case. It can be seen that the potential curves illustrated in FIG. 5D in the first time range (i.e., from the appearance of the ESD voltage pulse until about 10 ns afterwards) are not very different from the potential curves illustrated in FIG. 5C, so, at the time at which potential curve 21b in FIG. 5B has its maximum value, potential curve 21b in FIG. 5D has a similar value to potential curve 21b in FIG. 5C. However, the potential curves of FIG. 5D run considerably flatter after 10 ns or more after the appearance of the ESD voltage pulse than the potential curves in FIG. 5C, which can be attributed to the buffer capacitances which are larger by a factor of 5.

The example simulations have illustrated that embodiment described herein can considerably improve ESD protection of electronic circuits which have an external voltage supply line with a relatively small buffer capacity and an internal voltage supply line with comparatively considerably larger buffer capacities (e.g., larger than the buffer capacities of the external voltage supply line by more than a factor of 10).

Although specific embodiments have been illustrated and described herein, it will be appreciated by those of ordinary skill in the art that a variety of alternate and/or equivalent implementations may be substituted for the specific embodiments illustrated and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of electrostatic discharge (ESD) protection of an electronic circuit, the method comprising:
coupling a first circuit point of the electronic circuit to a first capacitance;
coupling a second circuit point of the electronic circuit to a second capacitance; and
substantially diverting an ESD voltage pulse occurring at the first circuit point via the second circuit point with the second capacitance.

2. The method according to claim 1, comprising:
arranging the first capacitance between the first circuit point and a supply potential (Vₛₛ);
arranging the second capacitance between the second circuit point and the supply potential (Vₛₛ); and
wherein substantially diverting includes diverting the ESD voltage pulse via the second capacitance to the supply potential (Vₛₛ).

3. The method according to claim 2, wherein the supply potential is ground (Vₛₛ).

4. The method according to claim 2, comprising:
coupling, with a terminal of the electronic circuit, the first circuit point to an external voltage supply in such a way that the first circuit point is coupled on a further supply potential of the electronic circuit defaulted by a potential of the terminal.

5. The method according to claim 4, comprising:
coupling the second circuit point on a voltage supply line of the electronic circuit to an internal voltage supply; and
providing, via the terminal of the electronic circuit, a potential of the voltage supply line to the external voltage supply.

6. The method according to claim 1, wherein the second capacitance is larger than the first capacitance.

7. The method according to claim 1, wherein the second capacitance is larger than the first capacitance by at least a factor of 10.

8. The method according to claim 1, comprising:
maintaining a potential of the second circuit point below a potential of the first circuit point when the electronic circuit is supplied normally with voltage in active operation.

9. The method according to claim 1, comprising:
providing a potential of the second circuit point that is at least 50% of a potential of the first circuit point when the electronic circuit is supplied normally with voltage in active operation.

10. The method according to claim 1, comprising:
maintaining a difference in amount between a potential of the first circuit point and a potential of the second circuit point of less than half of a sum of cut-off voltages of diodes when the electronic circuit is supplied normally with voltage in active operation.

11. A method of electrostatic discharge (ESD) protection of an electronic circuit having a terminal to an external voltage supply of the electronic circuit, the method comprising:
coupling a capacitance to a voltage supply line coupled to an internal voltage supply of the electronic circuit; and
substantially diverting an ESD voltage pulse occurring at the external voltage supply or at the terminal via the voltage supply line with the capacitance.

12. An electronic circuit comprising:
a first circuit point;
a second circuit point;
a first capacitance coupled to the first circuit point;
a second capacitance coupled to the second circuit point; and
a device having an input coupled to the first circuit point and an output coupled to the second circuit point, wherein the device is configured to divert an electrostatic discharge (ESD) voltage pulse occurring at the first circuit point to the second circuit point.

13. The electronic circuit according to claim 12, comprising:
a supply potential;
wherein the first capacitance is arranged between the first circuit point and the supply potential;
wherein the second capacitance is arranged between the second circuit point and the supply potential; and
wherein the device is configured to divert the ESD voltage pulse via the second capacitance to the supply potential.

14. The electronic circuit according to claim 13, wherein the supply potential is ground.

15. The electronic circuit according to claim 12, comprising:
a terminal to an external voltage supply;
a first voltage supply line, wherein the first circuit point is arranged on the first voltage supply line; and
a further supply potential defaulted by a potential of the terminal, wherein the first voltage supply line is coupled to the terminal such that the first voltage supply line is situated on the further supply potential.

16. The electronic circuit according to claim 15, comprising:
a second voltage supply line to an internal voltage supply, wherein the second circuit point is arranged on the second voltage supply line; and
wherein the electronic circuit is configured to regulate a potential of the second voltage supply line with the further supply potential.

17. The electronic circuit according to claim 16, comprising:
at least one first ESD protection arrangement coupled to the first voltage supply line and configured to conduct away an ESD voltage pulse applied to the first voltage supply line; and
at least one second ESD protection arrangement coupled to the second voltage supply line and configured to divert an ESD voltage pulse applied to the second voltage supply line.

18. The electronic circuit according to claim 16, comprising:
a plurality of devices, wherein in each device includes one input coupled to a different circuit point on the first voltage supply line and one output coupled to a different circuit point on the second voltage supply line, wherein each device is configured to divert an ESD voltage pulse occurring on the first voltage supply line to the second voltage supply line.

19. The electronic circuit according to claim 12, wherein the device comprises:
at least one diode arranged against a blocking direction between the first circuit point and the second circuit point.

20. The electronic circuit according to claim 19, wherein the at least one diode comprises a plurality of diodes arranged in series.

21. The electronic circuit according to claim 19, wherein a difference in amount between a potential of the first circuit point and a potential of the second circuit point is less than half the sum of the cut-off voltages of the at least one diode.

22. The electronic circuit according to claim 12, wherein the second capacitance is larger than the first capacitance.

23. The electronic circuit according to claim 12, wherein the second capacitance is larger than the first capacitance by at least a factor of 10.

24. The electronic circuit according to claim 12, wherein in a normal active operation of the electronic circuit a potential of the second circuit point is below a potential of the first circuit point.

25. The electronic circuit according to claim 12, wherein in a normal active operation of the electronic circuit a potential of the second circuit point is at least 50% of a potential of the first circuit point.

26. A electronic circuit comprising:
a terminal to an external voltage supply;
a voltage supply line to an internal voltage supply; and
means for diverting an electrostatic discharge (ESD) voltage pulse occurring at the terminal to the voltage supply line.

27. An electronic circuit comprising:
a terminal to an external voltage supply;
a first voltage supply line coupled to the terminal;
a first capacitance coupled to the first voltage supply line;
a second voltage supply line coupled to an internal voltage supply;
a second capacitance coupled to the second voltage supply line; and
a device configured to divert an electrostatic discharge (ESD) voltage pulse occurring at the terminal via the first voltage supply line to the second voltage supply line.

28. The electronic circuit according to claim 27, wherein the second capacitance is larger than the first capacitance by at least a factor of 10.

29. The electronic circuit according to claim 27, comprising:
a plurality of devices, wherein each device includes one input connected to a different circuit point on the first voltage supply line and one output connected to a different circuit point on the second voltage supply line, and each device is configured to divert an ESD voltage pulse occurring on the first voltage supply line to the second voltage supply line.
